(19) United States
(12) Patent Application Publication
(10) Pub. No.: US 2008/0210842 A1
(43) Pub. Date: Sep. 4, 2008

(54) BALANCING DEVICE

(75) Inventors: Wouter Dirk Van Dorsser, Delft (NL); Justus Laurens Herder, Delft (NL); Boudewijn Martin Wisse, Delft (NL); Rogier Barents, Den Hague (NL)

Correspondence Address: PEACOCK MYERS, P.C., 201 THIRD STREET, N.W., SUITE 1340, ALBUQUERQUE, NM, 87102, US

(73) Assignees: Technische Universiteit Delft, Delft (NL); InteSpring Holding B.V. i.o., Delft (NL)

(21) Appl. No.: 12/052,155

(22) Filed: Mar. 20, 2008

Related U.S. Application Data
(63) Continuation-in-part of application No. PCT/NL2006/050212, filed on Aug. 31, 2006.

(30) Foreign Application Priority Data
Sep. 20, 2005 (NL) 1029989

(51) Int. Cl. F16M 13/00

(52) U.S. Cl. 248/571

(57) ABSTRACT

A balancing device for a mass, comprising an arm that is adjustable about a pivoting point and with which the mass is coupled, and an adjustable spring system that is coupled with the arm, which spring system comprises at least one spring, wherein the spring system comprises an adjusting mechanism that is connected with the at least one spring, which adjusting mechanism is designed for adjusting the at least one spring so as to aid balancing the mass that is coupled with the arm, wherein a predetermined energy content of the spring system remains substantially the same.

### CROSS-REFERENCE TO RELATED APPLICATIONS

This application is a continuation-in-part application of Patent Cooperation Treaty (PCT) Application Serial No. PCT/NL2006/050212, entitled “BALANCING DEVICE”, to Technische Universiteit Delft and InteSpring Holding B.V., filed on Aug. 31, 2006, and the specification and claims thereof are incorporated herein by reference.

This application claims priority to and the benefit of the filing of Netherlands Patent Application Serial No. 1029989, entitled “BALANCING DEVICE”, filed on Sep. 20, 2005, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The invention relates to a balancing device for a mass, comprising an arm that is adjustable about a pivoting point and with which the mass is coupled, and an adjustable spring system that is coupled with the arm, which spring system comprises at least one spring.

2. Description of Related Art

Such a balancing device is used in numerous installations and products. Examples may include armrests, beds, cupboards.

From U.S. Pat. No. 4,387,876 such a balancing device is known which, however, has the drawback that the adjustment of the device involves the supply and dissipation of energy.

### BRIEF SUMMARY OF THE INVENTION

It is an object of the invention to provide a balancing device according to the preamble that can be adjusted with the least possible effort.

To this end the balancing device according to the invention is characterized, in that the spring system comprises an adjusting mechanism that is connected with the at least one spring, which adjusting mechanism is designed for adjusting (that is to say setting or adjusting) the at least one spring so as to aid balancing the mass that is coupled with the arm, wherein a predetermined energy content of the spring system remains substantially the same.

To this end the balancing device according to the invention is suitably and preferably embodied such that the adjusting mechanism is designed to allow ends of the at least one spring to move simultaneously during balancing in such a way, that the at least one spring maintains an invariant length.

To this end it is desirable that during balancing, the ends of the at least one spring undergo a translation and/or rotation.

Due to translation and/or rotation of the at least one spring, the force to be compensated is set. During rotation and/or translation the at least one spring is not extended or shortened, so that its energy content does not change. Although the force to be delivered by the at least one spring does not change either, the rotation and/or translation of the spring causes the point of application of said force to shift, thereby changing the moment that is applied on the arm coupled to the mass.

The inventors are of the opinion that the essence of the invention as explained in the above can be embodied in various different ways. Without pretensions to completeness, some of the possible embodiment variants will be discussed below.

### DETAILED DESCRIPTION OF THE INVENTION

### Industrial Applicability

A first preferred embodiment of the balancing device according to the invention is characterized in that the spring system comprises only one spring whose ends during balancing remain at a fixed distance from each other, and wherein the spring system possesses a coupling element that is moveable along the arm and can be fixed at predetermined positions on the arm.

The balancing device according to this first preferred embodiment may further be characterized in that the spring is mounted on the adjusting mechanism embodied as carriage, and in that the carriage can be moved along a stationary frame.

Still another version of this preferred embodiment is characterized in that during balancing, the coupling element is coupled with the carriage near an end of the spring.

The advantages gained with the above discussed preferred embodiment and its variants, as well as the advantages attached to the embodiments still to be discussed below, will become clear from the explanations for the Figures.

A second preferred embodiment of the balancing device according to the invention is characterized in that for the purpose of adjusting the at least one spring, the same is provided with a retaining nut for rendering at least a part of the at least one spring inactive.

This very simply allows the spring stiffness of the at least one spring to be varied whereby the balancing conditions are also adjustable.

A third preferred embodiment of the balancing device according to the invention is characterized, in that the spring system comprises two springs having first and second ends whose distance, during balancing, is for each separate spring invariable, wherein the first ends of both these springs have a rotatable coupling with the arm, and in that the second ends of the springs located opposite the first ends are coupled with the adjusting mechanism for positioning these second ends such that the adjusted springs are able to provide a force for balancing the arm.

Compared with the first preferred embodiment this third preferred embodiment affords the advantage that it can also be employed very well at low available working heights.

The third preferred embodiment is especially conveniently realized by embodying the same such that the adjusting mechanism possesses a pivoting point which, when the arm is in a predetermined position, has a common body axis with the rotatable coupling between the springs and the arm, and in that the adjusting mechanism further has a parallelogram construction with hinging corner points, wherein a corner point is moveably received in a vertical groove above the pivoting point of the arm.

The above discussed preferred embodiments of the balancing device according to the invention have as common feature that while the mass is being balanced, no changes occur in the individual energy content of the springs that are used.

However, the freedom of design may be extended without departing from the inventive idea by allowing the energy content of the springs to change, the precondition being, however, that the total energy content of the spring system does not change. This does not compromise the object of the invention, which is to effect adjustment of the balancing device with the least possible effort.

A fourth preferred embodiment of the balancing device based on this idea is characterized in that the spring system comprises two springs, wherein a first end of a first spring is rotatably coupled with the arm, and is at a second end, opposite the first end, coupled with the adjusting mechanism comprising a second spring, and in that in a predetermined position of the arm the adjusting mechanism is able to balance the arm, wherein a variation thus occurring in length of the first spring equals a converse variation in the length of the second spring, such that the combined energy content of the first and second spring remains constant. The energy content of a single spring, as already known, then equals the square of the extension of that spring.

This fourth preferred embodiment of the balancing device according to the invention may be conveniently realized thus that the adjusting mechanism is embodied as parallelogram construction with corner points, of which a corner point coincides with the point of rotation of the arm, and a corner point located diagonally thereto is moveably received in a vertically oriented slot, while the second spring extends diagonally between the two other corner points of the parallelogram construction.

Hereinafter the invention will be further elucidated by way of the four preferred embodiments of the balancing device according to the invention discussed above.

As already mentioned, these preferred embodiments are not limited with respect to the protective scope due the invention and the essence of which is expressed in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention.

The drawing of the preferred embodiments of the balancing device shows in;

FIG. 1 a first preferred embodiment;

FIG. 2 and FIG. 3 a second preferred embodiment in an operational—and an adjusting position, respectively;

FIG. 4a a spring system to be used in such a preferred embodiment;

FIG. 4b an adjusting mechanism to be used with the spring system shown in FIG. 3a, and

FIG. 5 a fourth preferred embodiment of the balancing device according to the invention.

Identical reference numerals used in the figures refer to similar components.

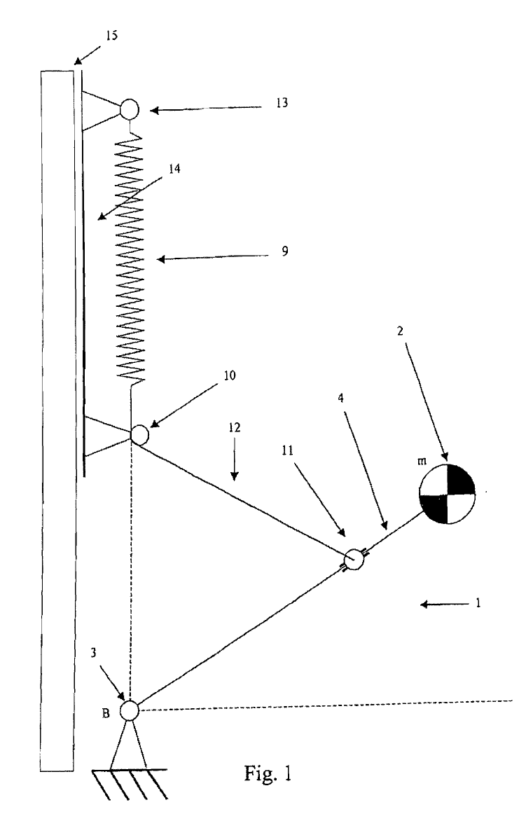

Referring first to FIG. 1, the first preferred embodiment of the balancing device 1 according to the invention will be explained.

The balancing device 1 serves for balancing a mass 2 and comprises an arm 4 that is adjustable about a point of rotation 3 and to which the mass 2 is coupled.

Also provided is an adjustable spring system 9 that is coupled with the arm 4.

Via connecting element 12 and a coupling member 11 provided at an end of this connecting element 12, the spring 9 is to this end coupled with the arm 4. The adjusting mechanism 14 is embodied as a carriage on which the spring 9 is provided. This spring is stretched between a fastening point 13 and a pulley 10 over which the connecting element 12 is guided.

When the arm 4 is placed vertically, a rebalancing of the arm 4 can be realized. In that vertical position of the arm 4, the pulley 10 and the coupling member 11 lie in each other's extended direction with respect to the point of rotation 3 of the arm 4. In this position, the spring 9 can assume a zero length entailing a predetermined pre-tension, which may actually also be zero.

The coupling member 11 is in that position preferably situated at the height of the pulley 10, and means are provided for fixing the coupling member 11 on the carriage 14.

As soon as the coupling member 11 is in that position, it may be loosened from the arm 4 so that as a result of the carriage 14 moving along the stationary frame 15 the arm 4 is enabled to rebalance, as the coupling member 11 is in this way able to move along the arm 4.

During the above-mentioned movement of the carriage 14 to enable the arm 4 to rebalance, the spring 9 maintains its length due to the fact that the distance between the fastening point 13 of the spring 9 and the coupling member 11 is unchanged.

When the coupling member 11 has reached the desired position along the arm 4, it may be fixed again on the arm 4, subsequent to which the arm 4 can be moved out of the vertical position and the coupling member 11 can be detached from the carriage 14. This carriage 14 and consequently also the pulley 10 thereon, must then also be fixed in the selected position along the stationary frame 15.

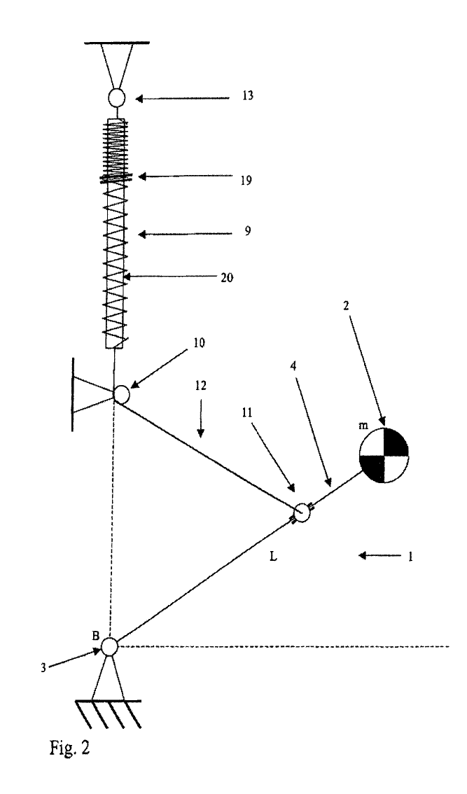

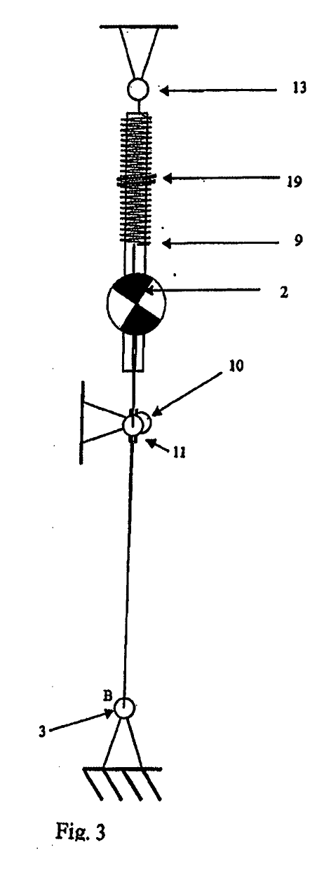

FIGS. 2 and 3 show a second preferred embodiment of the balancing device 1 according to the invention, wherein the adjustment of the balance is based on changing the setting of the spring constant of the at least one spring 9.

In a manner corresponding to the first preferred embodiment, the spring 9 is coupled with a connecting element 12 and a coupling member 11 provided at an end of said connecting element 12 for the purpose of coupling the spring 9 with the arm 4.

So as to be able to adjust the spring 9, it is provided with a bolt 20 and retaining nut. By means of this retention nut 19 a part of the spring 9 can be rendered inactive such that the spring constant of the remaining active part of the spring 9 can thereby be adjusted.

When adjusting the spring constant of the spring 9, it is important that the spring 9 is not under tension. In order to achieve this, the balancing device 1 is brought into the adjusting position shown in FIG. 3 with the coupling member 11 being located at the height of the pulley 10, so that a part of the spring 9 can simply be fixed with the aid of the retention nut 19.

After adjusting the retention nut 19 to realize a predetermined spring constant of the spring 9, the device 1 may be moved into the desired new balancing position.

In connection with the second preferred embodiment shown in the FIGS. 2 and 3, it should be noted that although the spring is shown to extend between a fixed fastening point 13 and a fixed pulley 10, this fastening point 13 and pulley 10 may, as in the manner shown in FIG. 1, also be positioned on a carriage 14.

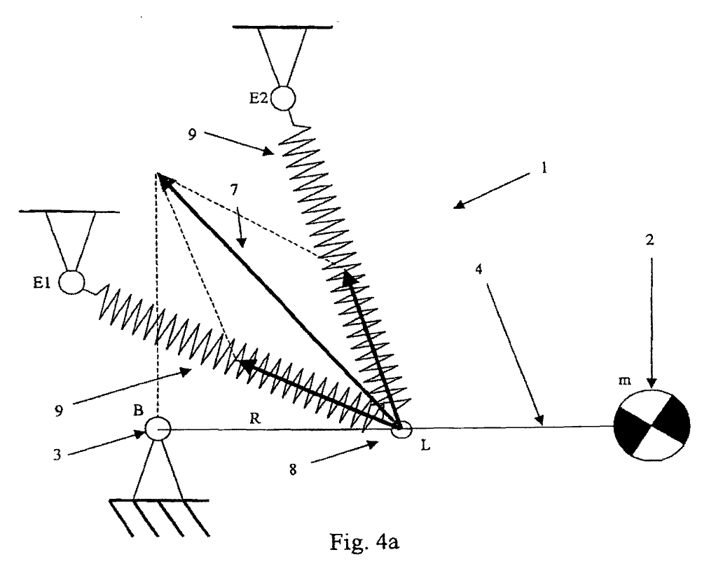

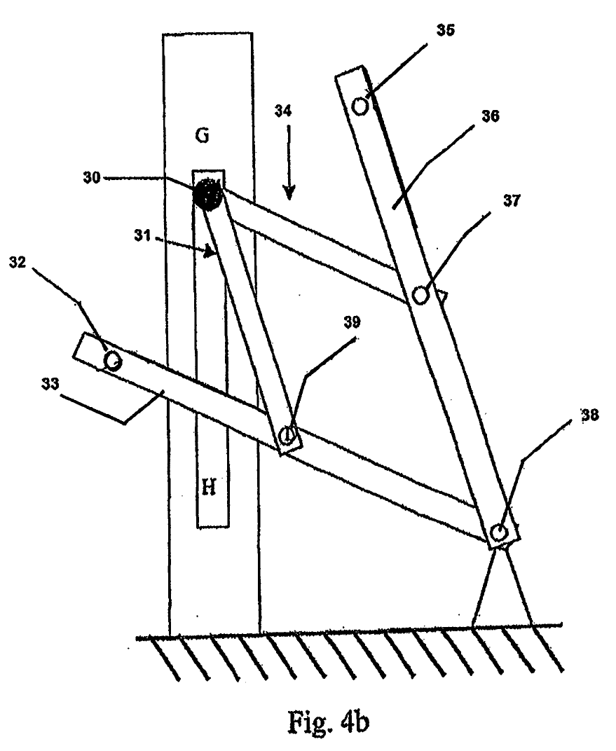

With reference to FIGS. 4a and 4b, a third preferred embodiment of the balancing device 1 according to the invention will be explained.

In order to render the working of the third preferred embodiment more understandable, the principle of the spring system to be used in the balancing device is explained with reference to FIG. 4a.

As shown in FIG. 4a, two springs 9 are used in this third preferred embodiment, each of which have a first end that is coupled to the arm 4 by means of a universal joint 8.

Opposite these first ends of the springs 9, said springs 9 have second ends E1 and E2, which are coupled with an adjusting mechanism 14, to be explained later with reference to FIG. 2b, for positioning these two ends E1 and E2 such as to enable the adjusted springs 9 and the arm 4 to deliver a balancing force.

In the horizontal position of the arm 4 shown, the point of rotation 8 is located at a position that, with the aid of the adjusting mechanism 14 of FIG. 4b, allows the two springs 9 to be rotated around this point of rotation 8 without changing the length of the springs 9.

These springs 9 are then dimensioned such that they, as it were, form a virtual spring element 7, whose end facing away from the arm 4, is located perpendicularly above the point of rotation 3 of the arm 4.

FIG. 4b shows an adjusting mechanism 14 to be used for this purpose.

This adjusting mechanism 14 has a point of rotation 18, which when the arm 4 is in the above-mentioned horizontal position, has a body axis in common with the universal joint 8 between the springs 9 and the arm 4. In other words: in an imaginary drawing where FIG. 4b is superimposed on FIG. 4a and the arm 4 is in the horizontal position, point of rotation 18 would be shown to coincide with point of rotation 8.

The adjusting mechanism 14 is embodied as parallelogram construction with hinging corner points 10, 17, 18 and 19, wherein the corner point 10, diagonally opposite point of rotation 18, is movably received in a vertical slot G-H extending above the point of rotation 3 of the arm 4.

The spring ends E1 and E2 of the spring 9 are coupled with end 12 of the extended parallelogram arm 13 and end 15 of the extended parallelogram arm 16, respectively.

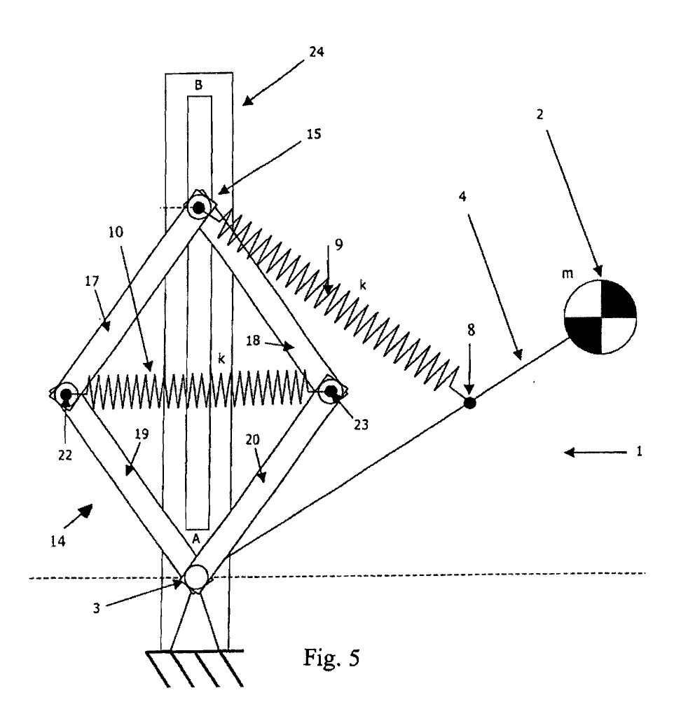

FIG. 5 finally shows a fourth preferred embodiment of the balancing device 1 according to the invention, wherein the spring system again comprises two springs 9.

In this fourth preferred embodiment, a first spring 9 is at its first end coupled via a universal joint 8 with the arm 4, and is provided at the second end, which lies opposite the first end, with a coupling 15 to an adjusting mechanism 14.

The adjusting mechanism 14 is in this fourth preferred embodiment further equipped with a second spring 10.

In a predetermined position of the arm 4, for example, in the horizontal position, the adjusting mechanism 14 can be adjusted in order to rebalance the arm 4, allowing in this case the length of the first spring 9 to increase or decrease, while the length of the second spring 10 is able to decrease casu quo increase equivalently. The total energy content of the first spring 9 and the second spring 10 remains constant, so that balancing with the aid of the adjusting mechanism 14 can take place without energy being supplied to or withdrawn from the total spring system 9, 10.

As shown in FIG. 5, the adjusting mechanism 14 is embodied as parallelogram construction with corner points, of which one corner point coincides with the point of rotation of the arm 4, while one corner point 15 located diagonally opposite is moveably received in a vertical slot A, B. The second spring 10 extends diagonally between the two other corner points 22, 23 of the adjusting mechanism 14.

The adjusting mechanism 14 is embodied such that after (re) balancing, the coupling 15 can be fixed in the position then attained.

What is claimed is:

1. A balancing device for a mass, comprising an arm that is adjustable about a pivoting point and with which the mass is coupled, and an adjustable spring system that is coupled with the arm, which spring system comprises at least one spring, wherein the spring system comprises an adjusting mechanism that is connected with the at least one spring, which adjusting mechanism is designed for adjusting the at least one spring when said arm is in a predetermined position so as to rebalance the mass so as to aid balancing the mass that is coupled with the arm, during which adjustment a predetermined energy content of the spring system remains substantially the same.

2. A balancing device according to claim 1, and wherein the adjusting mechanism is designed to allow ends of the at least one spring to move simultaneously during balancing in such a way that the at least one spring maintains an invariant length.

3. A balancing device according to claim 1, wherein during balancing, the ends of the at least one spring undergo a translation and/or rotation.

4. A balancing device according to claim 1, wherein the spring system comprises only one spring whose ends during balancing remain at a fixed distance from each other, and wherein the spring system possesses a coupling element that is moveable along the arm and can be fixed at predetermined positions on the arm.

5. A balancing device according to claim 1, wherein the spring is mounted on the adjusting mechanism embodied as carriage, and wherein the carriage can be moved along a stationary frame.

6. A balancing device according to claim 5, wherein during balancing, the coupling element is coupled with the carriage near an end of the spring.

7. A balancing device according to claim 1, wherein for the purpose of adjusting the at least one spring, the same is provided with a retaining nut for rendering at least a part of the at least one spring inactive.

8. A balancing device according to claim 1, wherein the spring system comprises two springs having first and second ends whose distance, during balancing, is invariable for each separate spring, wherein the first ends of both these springs have a rotatable coupling that connects with the arm, and wherein the second ends of the springs located opposite the first ends are coupled with the adjusting mechanism for positioning these second ends such that the adjusted springs are able to provide a force for balancing the arm.

9. A balancing device according to claim 8, wherein the adjusting mechanism possesses a pivoting point which, when the arm is in a predetermined position, has a common body axis with the rotatable coupling between the springs and the arm, and wherein the adjusting mechanism further has a parallelogram construction with hinging corner points, wherein a corner point is moveably received in a vertical groove above the pivoting point of the arm.

10. A balancing device according to claim 1, wherein the spring system comprises two springs, wherein a first end of a first spring has a rotatable coupling with the arm, and is at a second end, opposite the first end, coupled with the adjusting mechanism comprising a second spring, and wherein a predetermined position of the arm the adjusting mechanism is able to balance the arm, wherein a variation thus occurring in length of the first spring equals a converse variation in the length of the second spring, such that the combined energy content of the first and second spring remains constant.

11. A balancing device according to claim 10, wherein the adjusting mechanism is embodied as parallelogram construction with corner points, of which a corner point coincides with the point of rotation of the arm, and a corner point located diagonally thereto is moveably received in a vertically oriented slot, while the second spring extends diagonally between the two other corner points of the parallelogram construction.
